(19) United States
(12) Patent Application Publication
(10) Pub. No.: US 2021/0354105 A1
(43) Pub. Date: Nov. 18, 2021

(54) DEVICE AND PROCESS FOR IMPROVED PRODUCTION OF NOX COMPOUNDS USING NON-THERMAL PLASMA

(71) Applicant: Greenpath Industries, LLC, Brookville, FL (US)

(72) Inventor: Joseph E. Lewis III, Holly Hill, FL (US)

(21) Appl. No.: 17/318,477

(22) Filed: May 12, 2021

Related U.S. Application Data
(60) Provisional application No. 62/704,502, filed on May 13, 2020.

(51) Int. Cl. B01J 19/08; A01C 1/00; C01B 21/20

(52) U.S. Cl. CPC B01J 19/088; A01C 1/00; C01B 21/203; B01J 2219/0869; B01J 2219/0807; B01J 2219/0801; B01J 2219/0896

(57) ABSTRACT

An improved device and process for the production of oxides of nitrogen (NOx) having a novel plasma reactor assembly (105) with a gas and water injector (104) that mixes gas (10) and water (103) to produce gas and micro-fine water droplets (106) and injects same into a plasm reactor vessel (125) between electric diodes (128, 129) to yield a nitrous-rich plasma product (107) which is useful in a variety of commercial, agriculture, medical and industrial arenas.

### CROSS-REFERENCE TO RELATED APPLICATIONS

This application claims priority to the Utility Provisional Application No. 62/704,502 filed on May 13, 2020. It further relates to U.S. patent application Ser. No. 16/301,706 filed on Nov. 14, 2018 which is currently pending.

### BACKGROUND OF THE INVENTION

The present invention relates generally to the field of non-thermal plasma (NTP) technology. More specifically, it relates to a device and process used for the generation of reactive nitrogen species (RNS) and reactive oxygen species (ROS) or together as RONS. The device and process disclosed herein provides significant improvements in the reactivity and transfer of gas phase RONS into solvate. The advantage of this invention has to do with efficiency improvements made at the gas-liquid interface. This has resulted in a novel, highly concentrated solvate having high volumes of RONS, especially oxides of nitrogen (NOx) such as nitrite (NO2) and nitrate (NO3) which are highly useful in a variety of commercial, agricultural, medical and industrial industries.

Historically, anhydrous ammonia (NH3) has been used in agriculture industry as a nitrogen carrier in commercially manufactured fertilizer. The process to manufacture NH3 involves steam reformation of natural gas into hydrogen (H2) and carbon dioxide (CO2). The H2 is then combined with nitrogen over an iron catalyst under great pressure and temperature. This process requires significant amounts of energy and results in the generation of gross amounts of CO2. On a global scale, it is estimated that more than two percent of the world's energy output is used in ammonia fertilizer production; and, eighty-one percent of greenhouse gas emissions in 2018 was carbon dioxide. The huge amounts of energy consumed and the resulting pollution from agricultural fertilizers are persistent problems.

Additionally, runoff from agricultural operations using ammonia and other fertilizers is contaminating our planet's crucial water sources. The present invention discloses a solution that generates large amounts of NOx without the corresponding impacts to our planet's energy and natural resources. When used as a fertilizer, anhydrous ammonia requires the process of nitrification to generate useful nitrogen for the plant. In this process, NH3 must be exposed, under appropriate conditions, to ammonia-oxidizing bacteria such as Nitrosomonas, to make it available for uptake by plants. Typical ammonia and ammonia-based fertilizers have a nitrogen uptake efficiency in the range of eighteen to twenty-five percent. Runoff, ground leaching, evaporation and other factors suppress efficiencies and result in waste. A solution is needed that eliminates these steps to render fertilizer effective for nitrogen uptake by plants and that is further capable of producing NO2 and high levels of NO3 without going through a mineralization or nitrification process.

In addition to agriculture, a number of other industries rely heavily on NH3 and related nitrogen compounds. By way of example, and specifically not limiting other application of the present invention in other industries, the brewing industry uses large volumes of urea and the CO2 products in their fermentation process. Urea is a nitrogen source for test; problematically, it is known to contribute to the product of ethyl carbamate, a recognized carcinogen. What is needed is a source of nitrogen for the brewing industry that does not produce unwanted and potentially dangerous by-products.

Traditional synthetic nitrogen fertilizers such as urea, ammonium-nitrate and sodium-nitrate are considered salt compounds. When dissolved into irrigation water these compounds increase the salinity content, electrical conductivity and oxidative potential. Salinity is measured in parts per million (PPM) of dissolved solids or by electrical conductivity (EC). Appropriate salinity levels are especially critical when growing in a hydroponic or aeroponic setting, where excessive salinity reduces water availability to the plant by hindering water absorption and inducing physiological drought in the plant. There may be plenty of water available, but the plant roots are unable to absorb the water due to unfavorable osmotic pressure. In a soil based growing environment, nitrate salts can be used in greater abundance because of the beneficial bacteria that lives in the soil which performs the process of nitrification wherein the nitrogen salts are ultimately converted to NO3.

In a hydroponic or aeroponic system, there is no soil or beneficial bacteria to perform the function of transforming nitrate salts into pure NO3; this is by far the most significant and limiting factor associated with growth rate efficiency in these farming applications. What is needed is a source of pure nitrate that is not part of a salt compound. This would enable farmers to provide crops with higher volumes of NO3 without the detrimental effects associated with salt toxicity and greatly improve growth rate and production efficiency for all hydroponic and aeroponic farming.

Since the 1900's, it has been well known that plasma, in the form of atmospheric lightning will fixate nitrogen (N2) molecules in the atmosphere. The atmospheric lightning breaks the N2 apart into N where it can quickly bond with oxygen (O2) or ozone (O3) forming NO2 and NO3 collectively referred to as NOx. These NOx compounds become solvate within the falling rain, upon hitting the ground the NOx infused water is much more rapidly absorbed by plants than that of man-made nitrogen fertilizers that require fixation by chemical reactions from soil biologicals. The present invention utilizes NTP to duplicate the NOx production process found in nature by exposing O2 & N2 to a plasma discharge while in the presence of micro-fine water droplets.

The invention disclosed herein addresses several issues that have restricted the ability of previous devices to produce water containing high concentrations of NOx compounds. Significant improvements in NOx production as well as gas to liquid transfer efficiency were required in order to advance the technology to a commercially viable status. Further, this new technology needed to be scalable well beyond the system capabilities available today. This invention addresses these issues and discloses the specific details regarding how these improvements are accomplished.

The problem with other NTP systems designed to produce NOx in solvate is mostly centered around the inefficiencies associated with the mass transfer of gas phase RONS into water. Generally speaking, this issue has to do with the lack of penetration of the plasma discharge into the water. With an effective reach of only 1 to 2, most plasma discharges lack the ability to effectively transfer gas phase NOx into solvate with much of the gas being lost to the atmosphere. Another issue with existing NTP systems has to do with electrode life, these electrodes experience a relatively short service life due to the decomposition of the discharge surface from repeated striking on the same spot as well as thermal decomposition from lack of cooling.

In some devices, NOx gas produced in the plasma discharge but not transferred into the water, can be recirculated back into the system in order to improve the transfer efficiency. The intention is to increase the absorption of NOx into the water by further exposing the already excited gas species to the water a 2^{nd}, 3^{rd} or more times; at best, this only provides marginally improved results. In other devices or systems the unabsorbed gas containing NOx is bubbled into water using specialized methods and equipment that would disperse the gas into the water in the form of micro-fine bubbles. The idea here is to make the bubbles as small as possible, bubble them into a body of water far enough below the surface so as to allow them expand, and dissolve into the water on the rise to the surface. Again, this provides only marginal improvements as the water quickly reaches a saturation point from the transfer of undesirable gasses into solvate.

The present invention addresses the efficiency loss issues stated above. The disclosures made hereinafter will demonstrate to one skilled in the art the improvements made that were incorporated into this invention. As stated, the object of the present invention is to maximize the efficiency related to the production and transfer of RONS into a solvate. Additional improvements are disclosed that address the issues of electrode cooling and decomposition and system scalability.

Therefore, a need exists for an improved NTP device that creates a higher concentration of NOx and addresses the issues of system scalability.

### SUMMARY OF THE INVENTION

It is an object of this invention to provide a device and method for creating a highly concentrated NOx product that can be used in agricultural, medical, brewing, and multiple other industries.

It is a further object of this invention to generate reactive nitrogen and oxygen species in a form deliverable and readily useable by plants for optimized growth and agronomic productivity when needed. This invention enables growers to specifically alter the nutrient makeup, and therefore the nitrogen chemical efficacy of water supplied to plants, with watering.

It is another object of the invention to provide a device and process that allows for the on-site conversion of irrigation water into a carrier of highly valuable nitrogen oxides needed for healthy plant growth.

It is a separate object to provide a device and process that uses nitrogen and oxygen from atmospheric air to produce the nitrogen required by plants, including commercial crops.

It is also an object of the invention to provide a device and process that requires very little power to operate; and, based on testing may be capable of producing in excess of 2000 mg of nitrate per liter of water using less than 100 watts of electrical power.

It is another object of this invention to provide a device and process that is capable of producing water for plants containing metastable nitrogen and oxygen radicals in the desired concentration.

It is a different object to provide a source of pure nitrate that is not part of a salt compound that would enable farmers to provide crops with higher volumes of nitrogen and that can be used with other macro and micronutrients.

It is yet another object of this invention to provide a solution to the problems associated with using urea in the brewing industry by making a stable nitrogen source readily available to brewers without production of unhealthy or unstable by-products.

The term NPT is used throughout this disclosure to refer to the Non-Thermal Plasma that is generated within a device used to produce oxides of nitrogen (NOx). The term NOx is used throughout this disclosure to refer to oxides of nitrogen produced within the disclosed device and process.

The invention disclosed herein offers a solution to the persistent problem of agricultural pollution in runoff from farms using ammonia-based fertilizer to supply usable nitrogen to plants. The invention disclosed herein provides a clean, safe and non-polluting source of nitrogen that is not associated with a salt compound that is directly available to plants for uptake as they need it, in the form of metastable nitrogen and oxygen radicals. In this form, nitrogen is supplied without mineralization or nitrification, which can result in saving valuable time and money.

The invention disclosed herein maximizes the surface area of the water at the intersection of gas-water and plasma. This is accomplished using a specialized gas and water injector which delivers a combination of gas and micro-fine water droplets directly into the plasma reactor, the water droplets produced by the injector are very small with an average size of 8 to 12μ. Consider that an average size water droplet measures 1 mm in size, by converting that 1 mm size drop into 8-12μ size drops effectively increases the surface area by up to 125 times. The increase in surface area directly results in a significant increase in the transfer of RONS into the water in the plasma zone and minimizes the loss of gas phase RONS to atmosphere.

Another aspect of the invention addresses the issue of electrode deterioration associated sputtering, overheating and particle transfer. The system and electrodes disclosed in this patent effectively resolve the issues stated above in two ways. First, the electrodes disclosed in this patent are constructed using a larger discharge surface. The larger discharge surface greatly reduces premature electrode wear by distributing the arc discharge over a much greater area. The increased mass of the electrode and its wider arc discharge surface allows the electrode to run cooler through improved heat dissipation without any loss of performance. The electrodes are also cooled by the spray of gas and micro-fine water drops exiting the injector. Spraying water onto the surface of an electrode can quench the reaction or short out the plasma discharge completely. It is because of the small size of the micro-fine water drops that shorting and quenching are avoided while simultaneously providing enough water to reduce the electrode operating temperature and eliminate overheating issues.

The present invention fulfills the above and other objects by providing a device for NOx production using NTP to create a NOx product comprising of at least one plasma reactor assembly with at least one electrode, one feedthrough insulator, one plasma reactor vessel, one gas and water injector and a plasma zone that wherein the gas and micro-fine droplets of undergo a chemical transformation resulting in the creation of a highly concentrated NOx product.

The above and other objects, feature and advantages of the present invention should become even more readily apparent to those skilled in the art upon a reading of the following detailed description in conjunction with the drawings wherein there is shown and described illustrative embodiments of the invention.

### BRIEF DESCRIPTION OF THE DRAWINGS

In the following detailed description, reference will be made to the attached drawings in which:

FIG. 1 is an illustrated drawing of a system for enhanced NOx production in accord with this invention;

FIG. 2 is an illustration of a preferred embodiment of the NTP system using a gliding arc plasma reactor architecture having a dedicated gas and water injector positioned so as to direct a discharge of gas and water into a NTP high voltage discharge;

FIG. 3 shows four (4) different block diagrams that illustrate different processes used to supply gas to the NTP system. Each of the four systems is able to supply oxygen and nitrogen at various stoichiometric ratios under pressure to the NTP system. The on-off operation of the four systems can be performed from the NTP system control;

FIG. 4 is an illustration of a simplified process flow of the NOx production system, in accord with this invention;

FIG. 5 is an illustration of a simplified process flow of an alternative embodiment of the NOx production system having multiple NTP reactors and their related components to increase the production;

FIG. 6 is an illustration of a simplified process flow of a different alternative embodiment of the NOx production system having two or more injectors connected directly or indirectly to a manifold that supply's gas and water to a NTP reactor; and

FIG. 7 is an embodiment of a system and a process flow for an NTP based seed treatment system that exposes seeds directly to a dry or wet plasma discharge of water containing NOx, showing the seed treatment basket used to hold or support seeds securely in accord with this invention.

### DESCRIPTION OF THE PREFERRED EMBODIMENTS

For purposes of describing the preferred embodiment, the terminology used in reference to the numbered accessories in the drawings is as follows:
101 NOx production system
102 Gas
103 Water
104 Gas and Water Injector
105 Plasma reactor assembly
106 Gas and micro-fine water droplets
107 Product
108 Utility power
109 System control
110 Plasma ignition
111 Compressor
112 Water flow solenoid valve
113 Product receiving apparatus
114 O2 concentrator
115 Electrical power
116 Gas flow solenoid valve
117 Compressed oxygen tank
118 Compressed nitrogen tank
119 Seed treatment basket
120 Gas mixer
121 Collection jar
122 Seeds
123 Manifold
124 Gas flow regulator
125 Plasma reactor vessel
126 Plasma zone
127 Injector mount plate
128 Ignition electrode
129 Ground electrode
130 Feedthrough insulator
131 Mounting hardware
132 Ground connection
133 High voltage ignition lead
134 Water tank
135 Touch screen control
136 Mounting bracket
137 Cooling fan
138 Utility power cord
139 Device framework
140 On-board compressor system
141 Remote compressor system
142 Compressed gas system
143 Oxygen concentrator system
144 Gas flow control valve

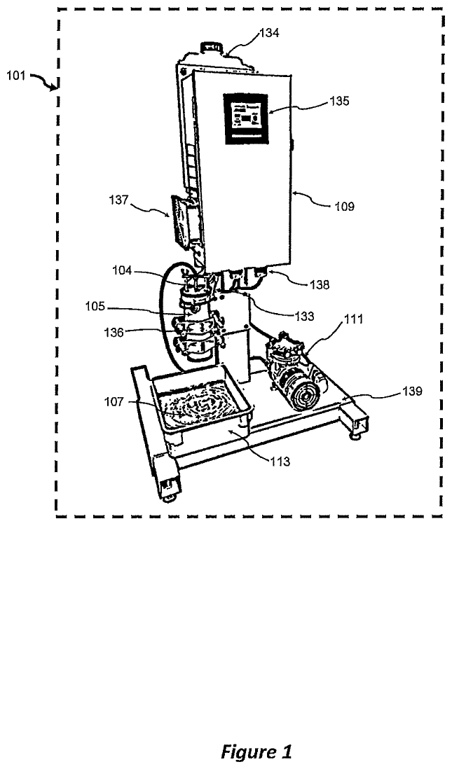

FIG. 1 is an illustrated drawing of a NOx production system 101 in accord with the present invention. This illustration represents one of several embodiments that are contemplated. The FIG. 1 illustration represents a benchtop model of the NOx production system 101. It should be noted that the NTP technology represented in FIG. 1 along with all of its supporting components are scalable in size, throughput and product 107 composition many times that of the benchtop model shown. It is the scalability of the NOx production system 101, utilizing the components and methods discussed herein that represent the true value of this technology.

Referring to FIG. 1, the NOx production system 101 is a composition of both proprietary and non-proprietary components working in unison to produce a product 107 that is a water containing high concentrations of NOx compounds that can be used within agriculture and numerous other industries. The NOx production system 101 shown in FIG. 1 features many components that are designed to perform very specific functions with the ultimate intent of producing product 107. The NOx production system 101 features a plasma reactor assembly 105 and a gas and water injector 104. The function of the plasma reactor assembly 105 is to produce product 107 by ionizing the gas and micro-fine droplets 106 (not shown) supplied by the gas and water injector 104. The remainder of the FIG. 1 discussion will include a description and function of its components so as to provide a detailed understanding of its operation.

The NOx production system 101 as shown in FIG. 1 is a completely self-contained NOx production system needing only to receive electrical power by connecting the utility power cord 138 into a nearby AC outlet. The NOx production system 101 is designed to utilize a multitude of utility power sources including 115-230 VAC 50 or 60 hz single phase. Larger versions of the NOx production system 101 may be configured to receive three-phase AC power or DC or solar and other directed generation power. The utility power cord 138 is connected to and supply's power to the system control 109 which contains various circuit breakers, relays, transformers and power distribution components not listed herein, as well as the plasma ignition 110. Attached to the system control 109 is the touch screen control 135 which provides the user with an easy-to-use interface for the operation of the NOx production system 101 including the ability to start and stop the production of product 107, configure run time duration, as well as selecting a wet or dry plasma seed treatment operation. The touch screen control 135 controls the stop and start operation of all systems and components of the NOx production system 101 including a compressor 111 which compresses gas 102 (not shown) and delivers it to the gas and water injector 104 via an undisclosed hose or conduit. The touch screen control 135 also controls the operation of a water flow solenoid valve 112 (not shown) which allows the flow of water 103 (not shown) to exit a water tank 134 and then pass through an undisclosed hose or conduit to the gas and water injector 104. Also controlled by the touch screen control 135 is the plasma ignition 110 (not shown). The plasma ignition 110 (not shown) converts utility power, whether AC or DC, into a high voltage and high energy discharge which is transferred to the plasma reactor assembly 105 by the high voltage ignition lead 133. The touch screen control 135 also energizes a cooling fan 137 which is used to cool all components located inside the control system 109. The touch screen control 135 may be activated by cellular transmission.

In operation the NOx production system 101 is operated by inputting the type of operation that is desired into the touch screen control 135, either plasma seed treatment or product 107 production. Next the operator inputs the desired operating time in minutes and hours. If the water tank 134 is empty it is to be filled with water 103 (not shown) prior to operation of the NOx production system 101. Next, the product receiving apparatus 113 or collection jar 121 (not shown) should be placed under the plasma reactor vessel 125 depending on the mode of operation. The NOx production system 101 is then activated by touching the start indicator on the touch screen control 135, when this is done there is a simultaneous start-up of the compressor 111, cooling fan 137, water flow solenoid valve 112 (not shown) and the plasma ignition 110 (not shown). Once all of these components are energized, the compressor 111 will immediately deliver gas 102 (not shown) to the gas and water injector 104. At the same time, the water flow solenoid valve 112 (not shown) will allow water 103 (not shown) to travel from the water tank 134 to the gas and water injector 104. The gas and water injector 104 injects gas and micro-fine water droplets 106 (not shown) into the plasma reactor vessel 125 where they are converted into product 107. The product 107 exits the bottom of the plasma reactor vessel 125 directly into the product receiving apparatus 113 or collection jar 121 (not shown), depending on the mode of operation selected.

The components of the NOx production system 101 are all connected to a device framework 139 which allows secure mounting of the compressor 111, the water tank 134, the system control 109, and mounting brackets 136 which are used to support the plasma reactor assembly 105. Larger scale NOx production systems 101 not shown may include more or less components and would likely be configured differently, but functionally the same.

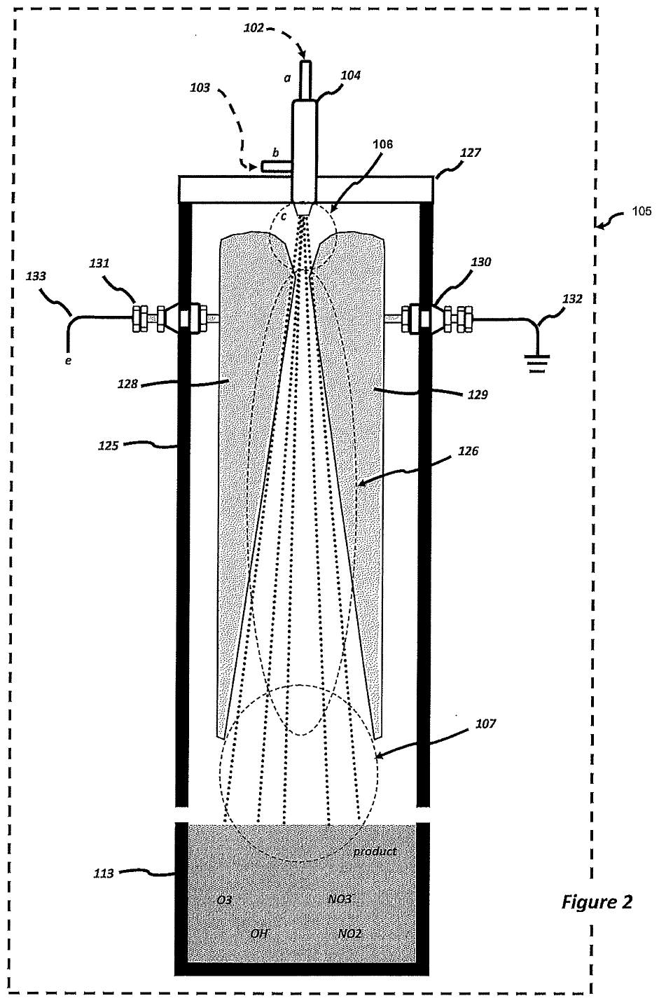

FIG. 2 provides an illustration of the plasma reactor assembly 105 and gas and water injector 104. While the plasma reactor assembly 105 illustrated in FIG. 2 is a preferred embodiment of the present invention, it is contemplated that numerous variations of the invention are possible and are considered to be within the scope of this disclosure.

The FIG. 2 drawing presents the use of a gliding arc type NTP architecture employed in the plasma reactor assembly 105. The plasma reactor assembly 105 is comprised of several components. These include a plasma reactor vessel 125 which is preferably a cylindrical shaped, non-electrically conductive tube. Inside the plasma reactor vessel 125 is one or more ground electrodes 129 and one or more ignition electrodes 128. Both the ground electrodes 129 and ignition electrodes 128 are configured to allow their electrical connections to pass through a feedthrough insulator 130 which is mounted to the inner and outer wall of the plasma reactor vessel 125. The ground electrodes 129, ignition electrodes 128 and feedthrough insulators 130 are held in place to the plasma reactor vessel 125 by the mounting hardware 131. At the top of the plasma reactor vessel 125 is the injector mount plate 127. The injector mount plate 127 is made from a preferably non-electrically conductive and water resistant material, and can be affixed to the plasma reactor vessel 125 by a wide-band hose clamp not shown in this illustration. The center of the injector mount plate 127 is bored to allow the gas and water injector 104 to be pressed into it in such a way that it is centered directly above the inside edge of the ground electrodes 129 and ignition electrodes 128.

In operation, the plasma reactor assembly 105 produces product 107 in the following steps. When the NOx production system 101 (not shown) is turned on using the touch screen control 135 (not shown), electrical power 115 (not shown) is supplied to the plasma ignition 110 (not shown) and ultimately to the ignition electrode 128 by the high voltage ignition lead 133 (not shown). This immediately creates an arc between the ignition electrodes 128 and the ground electrodes 129. The gap or area between the ignition electrode 128 and ground electrode 129 is the plasma zone 126. Further, when the NOx production system 101 (not shown) is turned on using the touch screen control 135 (not shown) electrical power 115 (not shown) is supplied to the compressor 111 (not shown) which immediately supply's gas 102 to the to the “a” connection of the gas and water injector 104. Simultaneously, electrical power 115 (not shown) is supplied to the water flow solenoid valve 112 (not shown) which allows the flow of water 103 to flow into the “b” connection of the gas and water injector 104. With both gas 102 and water 103 supplied to the gas and water injector 104 a discharge of gas and micro-fine water droplets 106 exits from the “c” connection of the gas and water injector 104. The first thing the gas and micro-fine water droplets 106 contact upon exiting the “c” connection of the gas and water injector 104 is a high voltage arc generated between the ignition electrode 128 and the ground electrode 129; immediately, the arc is stretched forming a plasma within the plasma zone 126. In the plasma zone 126 the gas and micro-fine water droplets 106 undergo a chemical transformation resulting in the creation of the product 107. As the product 107 exits the plasma reactor vessel 125, it moves into a product receiving apparatus 113 where it can be stored, used or transferred to another location.

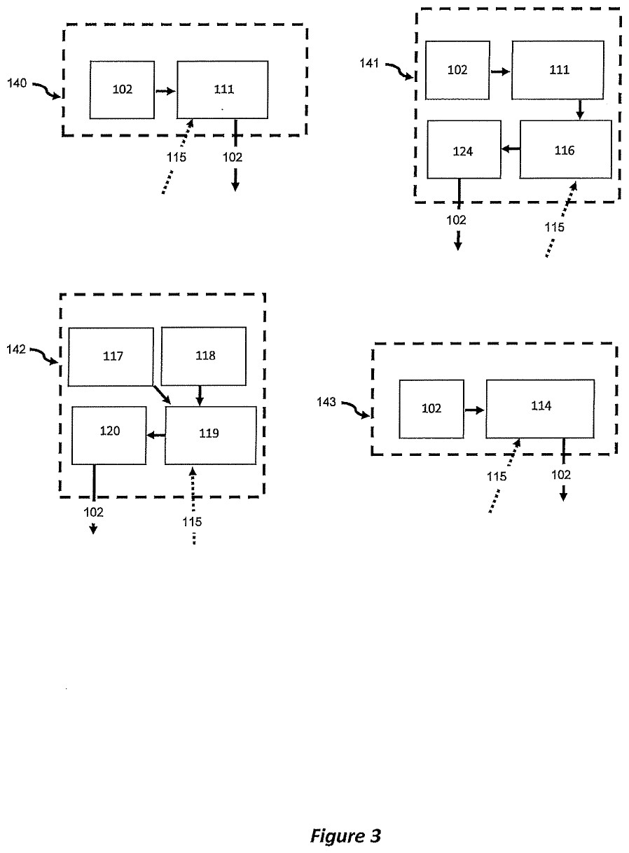

FIG. 3 is a series of block diagrams that represent alternative embodiments relating to a gas compression and delivery system in accordance with the present invention. Each of the four (4) embodiments illustrated in FIG. 3 represents a source and method of delivering a greater or lesser volume of gas 102 to the NOx production system 101 (not shown) or the ability to deliver a specific stoichiometric mixture of oxygen and nitrogen which could improve the NOx concentration in product 107 (not shown).

In FIG. 3, the on-board compressor system 140 is a preferred embodiment as shown and discussed in FIG. 1. The on-board compressor system 140 is mounted to the device framework 139 (not shown). The gas 102 source of the on-board compressor system 140 is atmospheric air which is compressed by the compressor 111 and supplied to the gas and water injector 104 (not shown) via an undisclosed hose or conduit.

In operation, the on-board compressor system 140 receives electrical power 115 from the system control 109 (not shown) when the touch screen control 135 (not shown) is operated. Specifically, the compressor 111 receives the electrical power 115 and starts the operation of compressing gas 102 and sending it to the gas and water injector 104 (not shown) via an undisclosed hose or conduit.

Another embodiment of a gas compression and delivery system is the remote compression system 141. Unlike the on-board compressor system 140, the remote compressor system 141 is not mounted to the device framework 139 (not shown) but is rather located elsewhere. The remote compressor system 141 consists of a compressor 111, a gas flow solenoid valve 116 and a gas flow regulator 124 which reduces gas pressure in accordance with specified operating pressure requirements of the gas and water injector 104 (not shown). The compressor 111 may include a separate storage tank to store large volumes of compressed gas 102 not listed here; it could also have a dedicated power supply that is independent of the NOx production system 101 (not shown).

In operation, the gas flow solenoid valve 116 receives electrical power 115 from the system control 109 (not shown) when the touch screen control 135 (not shown) is operated. This allows the sending of gas 102 to the gas and water injector 104 (not shown) via an undisclosed hose or conduit.

In another embodiment of a gas delivery system is the compressed gas system 142, unlike the on-board compressor system 140 and the remote compressor system 141 the compressed gas system 142 does not include a compressor 111. The compressed gas system 142 includes a compressed oxygen tank 117, a compressed nitrogen tank 118, a gas flow control valve 144, and a gas mixer 120.

In operation, the compressed gas system 142 works as follows. Both the compressed oxygen tank 117 and compressed nitrogen tank 118 are connected to the gas flow control valve 144 via an undisclosed hose or conduit, the gas flow control valve 144 receives electrical power 115 from the system control 109 (not shown). When the touch screen control 135 (not shown) is operated, this allows the sending of precise volumes of each gas 102 to exit the gas flow control valve 144 and into the gas mixer 120 where they are mixed into a homogenous mixture of gas 102. From the gas mixer 120 the gas 102 travels to the gas and water injector 104 via an undisclosed hose or conduit.

Another embodiment of a gas delivery system is the oxygen concentrator system 143. The oxygen concentrator system 143 utilizes the oxygen concentrator 114 and is similar to the on-board compressor system 140 in that it mounts to the device framework 139 (not shown). A unique aspect of the oxygen concentrator 114 is that it incorporates a built-in compressor as well as a pressure swing absorption device which allows it to increase the percentage of oxygen in the gas 102.

In operation, the oxygen concentrator system 143 works as follows, the oxygen concentrator system 143 receives electrical power 115 from the system control 109 when the touch screen control 135 (not shown) is operated, this allows the transport of gas 102 to the gas and water injector 104 via an undisclosed hose or conduit.

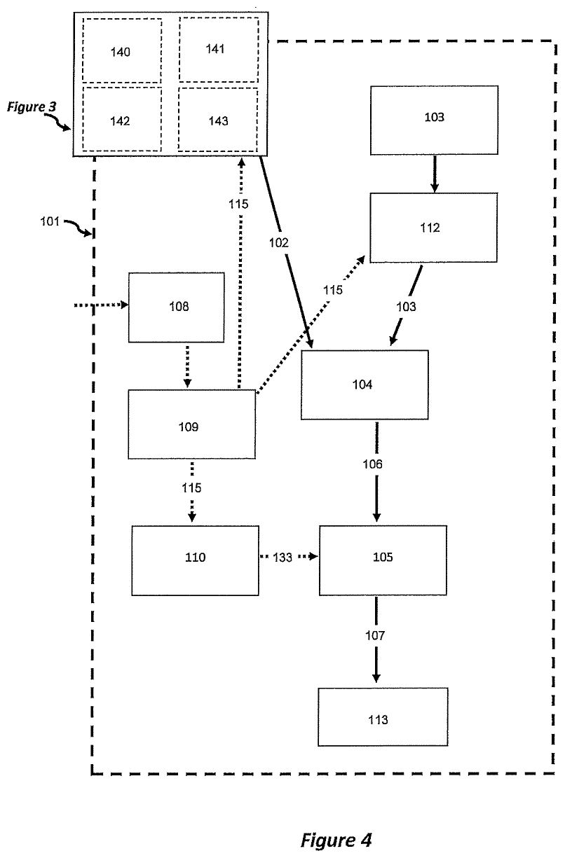

FIG. 4 illustrates a simplified process diagram for the present invention. Within the NOx production system 101, gas 102 and water 103 are supplied to a gas & water injector 104. The gas 102 is supplied by one of the four methods or systems discussed in the FIG. 3 detailed description. The FIG. 4 drawing illustrates the role of the various components making up the NOx production system 101.

The NOx production system 101 ultimately produces product 107 via the use of utility power 108, gas 102 and water 103. The utility power 108 is supplied to the NOx production system 101 by connecting the utility power cord 138 (not shown) into a standard 15 amp wall outlet; alternatively, the utility power cord 138 (not shown) may be hard wired directly to a power distribution box or other type of power supply not shown. The utility power cord 138 (not shown) delivers utility power 108 directly to the control system 109 which is made up of circuit breakers, relays, power converters, transformers and power distribution devices as well as the plasma ignition 110, all not shown in this illustration. A touch screen control 135 (not shown) is mounted into the control system 109. The touch screen control 135 (not shown) is an interface device that allows a user to operate the NOx production system 101 in the manner and timing desired. When the touch screen control 135 (not shown) and the system control 109 is used to activate the NOx production system 101 into operation, it does so by providing electrical power 115 to the plasma ignition 110, the water flow solenoid valve 112, the cooling fan 137 (not shown) and to one of the four gas 102 supply systems illustrated in FIG. 3. When these steps occur, water 103 flows from the water tank 134, through the water flow solenoid valve 112 and into the gas and water injector 104 via an undisclosed hose or conduit. Simultaneously, gas 102 is supplied from one of the four gas supply systems illustrated in FIG. 3 to the gas and water injector 104. With both gas 102 and water 103 supplied to the gas and water injector 104 a discharge of gas and micro-fine water droplets 106 exit the “c” connection (as shown in FIG. 2) of the gas and water injector 104 and flow into the plasma zone 126 inside of the plasma reactor vessel 125. Within the plasma zone 126 (not shown), the gas and micro-fine water droplets 106 undergo a chemical transformation wherein the gas is ionized, radicalized and becomes very unstable while in the presence of micro-fine droplets of water. The micro-fine droplets of water are very small, typically between 8μ and 20μ in size. At this size, the gas and micro-fine droplets of water 106 are able to be evenly dispersed within the plasma zone 126 without quenching or shorting out the plasma discharge. Because of the small size of the gas and micro-fine droplets of water 106 they present a significant advantage in the efficiency of transfer of reactive nitrogen species (RNS) into the water. The micro-fine droplets of water, when compared volume for volume, dramatically increase the exposed surface area of water by as much as 125 times when compared to a standard 1 mm size water 103 droplet. It is for these reasons that the NOx concentration of the product 107 is much higher than other types of plasma systems designed to produce Plasma Activated Water (PAW).

As mentioned above, the product 107 is created within the plasma zone 126 of the plasma reactor assembly 105. The product 107 then exits the plasma reactor vessel 125 directly into the product receiving apparatus 113. The product receiving apparatus 113 may be in the form of an open top tray with sides, a bucket, or a sealed and vented tank of various size or some other means of securely storing the product 107.

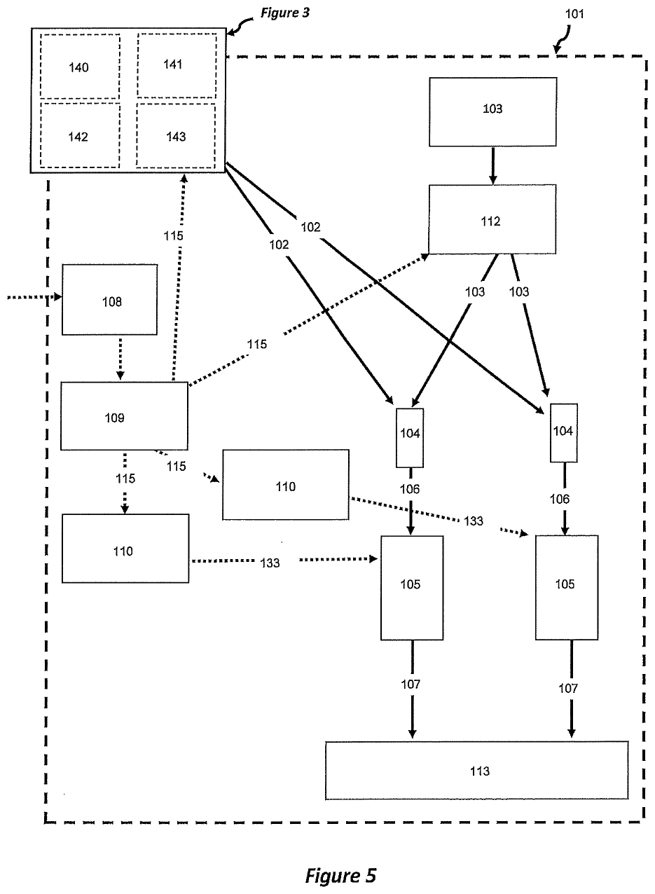

FIG. 5 illustrates a simplified process diagram for the present invention. Within the NOx production system 101, gas 102 and water 103 are supplied to two or more gas & water injectors 104. The gas 102 is supplied by one of the four methods or systems discussed in the FIG. 3 detailed description. The FIG. 5 drawing illustrates the role of the various components making up the NOx production system 101.

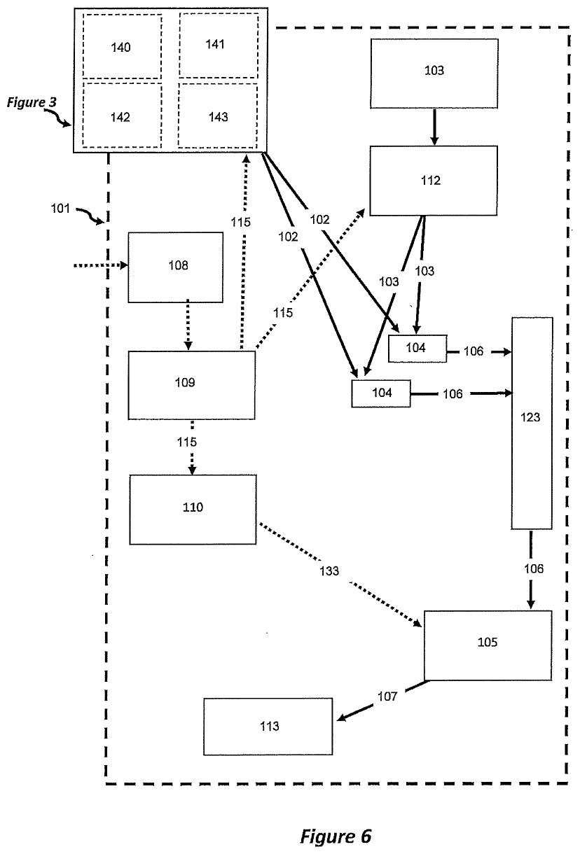

The NOx production system 101 ultimately produces product 107 via the use of utility power 108, gas 102 and water 103. The utility power 108 is supplied to the NOx production system 101 by connecting the utility power cord 138 (not shown) into a standard 15 amp wall outlet; alternatively, the utility power cord 138 (not shown) may be hard wired directly to a power distribution box or other type of power supply not shown. The utility power cord 138 (not shown) delivers utility power 108 directly to the control system 109 which is made up of circuit breakers, relays, power converters, transformers and power distribution devices all not shown in this illustration as well as the plasma ignition 110. A touch screen control 135 (not shown) is mounted into the control system 109. The touch screen control 135 (not shown) is an interface device that allows a user to operate the NOx production system 101 in the manner and timing desired. When the touch screen control 135 (not shown) and the system control 109 is used to activate the NOx production system 101 into operation, it does so by providing electrical power 115 to two or more plasma ignitions 110, the water flow solenoid valve 112, the cooling fan 137 (not shown) and to one of the four gas 102 supply systems illustrated in FIG. 3. When these steps occur, water 103 flows from the water tank 134, through the water flow solenoid valve 112 and into two or more of the gas and water injectors 104 via an undisclosed hose or conduit. Simultaneously, gas 102 is supplied from one of the four gas supply systems illustrated in FIG. 3 to two or more of the gas and water injectors 104. With both gas 102 and water 103 supplied to the gas and water injectors 104 a discharge of gas and micro-fine water droplets 106 exit the “c” connection (as shown in FIG. 2) and flows into the plasma zone 126 inside of two or more plasma reactor vessels 125. Within the plasma zone 126 the gas and micro-fine water droplets 106 undergo a chemical transformation where the gas is ionized, radicalized and becomes very unstable while in the presence of micro-fine droplets of water. The micro-fine droplets of water are very small, typically between 8μ and 20μ in size, at this size, the gas and micro-fine droplets of water 106 are able to be evenly dispersed within the plasma zone 126 without quenching or shorting out the plasma discharge. Because of the small size of the gas and micro-fine droplets of water 106 they present a significant advantage in the efficiency of transfer of reactive nitrogen species (RNS) into the water. The gas and micro-fine droplets of water 106, when compared “volume for volume” dramatically increase the exposed surface area of the water by as much as 125 times when compared to a standard 1 mm size water 103 droplet. It is for these reasons that the NOx concentration of the product 107 is much higher than other types of plasma systems designed to produce Plasma Activated Water (PAW). As mentioned above, the product 107 is created within the plasma zone 126 of the two or more plasma reactor assemblies 105. The product 107 then exits the plasma reactor vessel 125, directly into the product receiving apparatus 113 via an undisclosed hose or conduit. The product receiving apparatus 113 may be in the form of an open top tray with sides, a bucket, or a sealed and vented tank of various size or some other means of securely storing the product 107. FIG. 6 illustrates a simplified process diagram for the present invention. Within the NOx production system 101, gas 102 and water 103 are supplied to two or more gas & water injectors 104. The gas 102 is supplied by one of the four gas delivery systems discussed in the FIG. 3 detailed description. The FIG. 6 drawing illustrates the role of the various components making up the NOx production system 101.

The NOx production system 101 ultimately produces product 107 via the use of utility power 108, gas 102 and water 103. The utility power 108 is supplied to the NOx production system 101 by connecting the utility power cord 138 (not shown) into a standard 15 amp wall outlet, alternatively, the utility power cord 138 (not shown) may be hard wired directly to a power distribution box or other type of power supply not shown. The utility power cord 138 (not shown) delivers utility power 108 directly to the control system 109 which is made up of circuit breakers, relays, power converters, transformers and power distribution devices all not shown, as well as the plasma ignition 110. A touch screen control 135 (not shown) is mounted into the control system 109, the touch screen control 135 (not shown) is an interface device that allows a user to operate the NOx production system 101 in the manor and timing desired. When the touch screen control 135 (not shown) and the system control 109 is used to activate the NOx production system 101, it does so by providing electrical power 115 to the plasma ignition 110, the water flow solenoid valve 112, the cooling fan 137 (not shown) and to one of the four gas supply systems illustrated in FIG. 3. When these steps occur, water 103 flows from the water tank 134, through the water flow solenoid valve 112 and into two or more of the gas and water injectors 104 via an undisclosed hose or conduit. Simultaneously, gas 102 is supplied from one of the four gas supply systems illustrated in FIG. 3 to two or more of the gas and water injectors 104. With both gas 102 and water 103 supplied to the gas and water injectors 104 a discharge of gas and micro-fine water droplets 106 exit the “c” connection (as shown in FIG. 2) of the gas and water injectors 104 and flow into a manifold 123 which is configured to allow the connecting of two or more gas and water injectors 104. By connecting two or more gas and water injectors 104 to the manifold 123 that in turn increases the volume of gas and micro-fine water droplets 106 flowing through it.

Within the plasma zone 126 the gas and micro-fine water droplets 106 undergo a chemical transformation where the gas is ionized, radicalized and becomes very unstable while in the presence of the micro-fine droplets of water. The micro-fine droplets of water are very small, typically between 8μ and 20μ in size, at this size, the micro-fine droplets of water are able to be evenly dispersed within the plasma zone 126 without quenching or shorting out the plasma discharge. Because of the small size of the gas and micro-fine droplets of water 106 they present a significant advantage in the efficiency of transfer of reactive nitrogen species (RNS) into the water. The gas and micro-fine droplets of water 106, when compared “volume for volume” dramatically increase the exposed surface area of the water by as much as 125 times when compared to a standard 1 mm size water 103 droplet. It is for these reasons that the NOx concentration of the product 107 is much higher than other types of plasma systems designed to produce Plasma Activated Water (PAW).

As mentioned above, the product 107 is created within the plasma zone 126 of the two or more plasma reactor assemblies 105, from the plasma reactor vessel 125. The product 107 then exits the plasma reactor vessel 125 directly into the product receiving apparatus 113. The product receiving apparatus 113 may be in the form of an open top tray with sides, a bucket, or a sealed and vented tank of various size or some other means of securely storing the product 107.

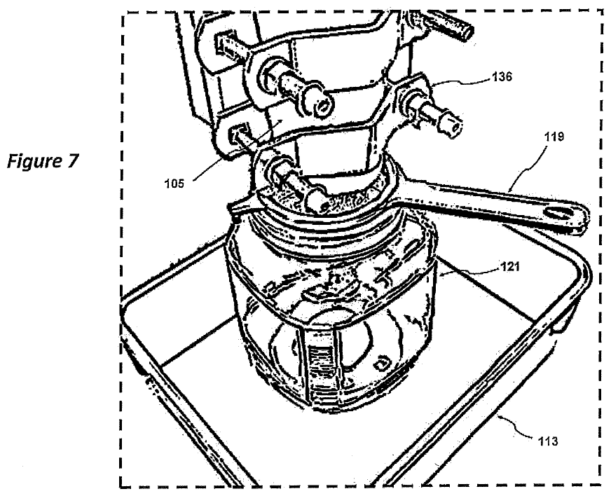

FIG. 7 illustrates a method and system of treating seeds by exposing them to a non-thermal plasma discharge using the NOx production system 101 (not shown). The NOx production system 101 (not shown) is a multi-faceted technology, designed to both produce product 107 but can also be configured to treat seeds with either a wet or dry plasma discharge. The ability to treat seeds with plasma starts by engaging the touch screen control 135 (not shown) and selecting a wet or dry plasma seed treatment mode. If the wet seed treatment mode is selected, the touch screen control 135 (not shown) and the system control 109 (not shown) is used to activate the NOx production system 101 (not shown) into operation. It does so by providing electrical power 115 (not shown) to the plasma ignition 110 (not shown) the water flow solenoid valve 112, (not shown), the cooling fan 137 (not shown) and to one of the four gas 102 (not shown) supply systems illustrated in FIG. 3. When these steps occur, gas 102 (not shown) flows from one of the four gas 102 (not shown) supply systems illustrated in FIG. 3 to the gas and water injector 104 (not shown) via an undisclosed hose or conduit. Water 103 (not shown) then flows from the water tank 134 (not shown), through the water flow solenoid valve 112 (not shown) and into the gas and water injector 104 (not shown) via an undisclosed hose or conduit. When operating in a seed treatment mode a collection jar 121 is placed inside of the product receiving apparatus 113. Seeds 122 (not shown) are placed inside the seed treatment basket 119. The seed treatment basket 119 is then placed on top of the collection jar 121. The product receiving apparatus 113 is next placed on the device framework 139 so as to align the seed treatment basket 119 directly under the bottom of the plasma reactor assembly 105 which would allow the seeds 122 (not shown) to be exposed to plasma filaments, radicals, ions, charged particles, reactive oxygen and nitrogen species and product 107.

If the dry seed treatment mode is selected, the touch screen control 135 (not shown) and the system control 109 (not shown) is used to activate the NOx production system 101 (not shown) into operation. It does so by providing electrical power 115 to the plasma ignition 110, the cooling fan 137 (not shown) and to one of the four gas 102 (not shown) supply systems illustrated in FIG. 3. When these steps occur, gas 102 (not shown) flows from one of the four gas 102 (not shown) supply systems illustrated in FIG. 3 to the gas and water injector 104 (not shown) via an undisclosed hose or conduit. When operating in a seed treatment mode a collection jar 121 is placed inside of the product receiving apparatus 113. Seeds 122 are placed inside the seed treatment basket 119, the seed treatment basket 119 is then placed on top of the collection jar 121, the product receiving apparatus 113 is next placed on the device framework 139 so as to align the seed treatment basket 119 directly under the bottom of the plasma reactor assembly 105 which would allow the seeds 122 to be exposed to plasma filaments, radicals, ions, charged particles, reactive oxygen and nitrogen species.

It is to be understood that while a preferred embodiment of the invention is illustrated, it is not to be limited to the specific form or arrangement of parts herein described and shown. It will be apparent to those skilled in the art that various changes may be made without departing from the scope of the invention and the invention is not to be considered limited to what is shown and described in the specification and the drawings.

Having thus described the invention, we claim:

1. A device for NOx production using non-thermal plasma to create a NOx product comprising:
a) at least one plasma reactor assembly, further comprising:
i. at least one electrode;
ii. at least one feedthrough insulator;
iii. at least one plasma reactor vessel;
iv. at least one gas and water injector mounted on top of the plasma reactor vessel; and
v. at least one plasma zone that includes the area surrounding the at least one electrode located above the exit area of the plasma reactor vessel;
b) an electrical system control, including ignition connection hardware and a plasma ignition unit electronically connected to the at least one electrode wherein said plasma ignition unit is configured to operate at a predetermined voltage and frequency;
c) an air supply unit further comprising: an air pump removably attached to an air filter and in contact with an external air supply, said air pump pressurizes filtered air and releases it to an air hose, said air hose is connected at a first end to the air pump and connected at a second end to the gas and water injector which is removably connected to the plasma reactor vessel; and
d) a water injection unit further comprising a water supply, an external pressurized water supply line connected to said water supply; a manual shutoff valve on said external pressurized water supply line between the solenoid valve and a water flow regulator; a water injection hose with a first end connected to the water flow regulator and a second end connected to the gas and water injector which is removably connected to the plasma reactor vessel.

2. The device of claim 1, wherein the at least one electrode further comprises a tapered electrode body with a first end and a second end, wherein said first end has a larger area than said second end, and wherein electricity passing between said first end and said second end establishes a plasma zone in which the gas and micro-fine water droplets undergo a chemical transformation resulting in the creation of a highly concentrated NOx product.

3. The device of claim 1, wherein the at least one feedthrough insulator is mounted to the inner and outer wall of the plasma reactor vessel to allow electrical connections of the at least one electrode to be established.

4. The device of claim 1, wherein the at least one plasma reactor assembly further comprises:
a) at least one ground electrode, at least one ignition electrode connected to the at least one feedthrough insulator configured to allow electrical connections, said at least one feedthrough insulator being held in place by mounting hardware;
b) at least one injector mounting plate located at the top of the at least one plasma reactor vessel having a center of the at least one injector plate bored to allow placement of the at least one gas and water injector, said gas and water injector being centered directly above the at least one ground electrode and the at least one ignition electrode;
c) at least one gas and water injector having both gas and water supplied to said at least one gas and water injector which results in a discharge of micro-fine water droplets exiting from the at least one gas and water injector with said micro-fine water droplets coming in direct contact with a high voltage arc between the at least one ignition electrode and the at least one ground electrode; and
d) at least one plasma zone in which gas and micro-fine water droplets undergo a chemical transformation resulting in the creation of the highly concentrated NOx product.

5. The device of claim 1, wherein the electrical system control further comprises a system control unit capable of controlling system functionality; control power supply circuitry connecting the system control unit to the device, further comprising a main power supply circuit including at least one low voltage power circuit and at least one relay switch connecting and controlling said main power control circuit with the at least one low-voltage power circuit and an ignition power line, an air pump power line and an ignition unit power line, a plasma ignition unit connected with the plasma reactor vessel via a high voltage ignition line; a solenoid valve connected to the external pressurized water supply line of the water control unit; and an air pump.

6. A NOx production process using the device of claim 1 comprising:
I. operating the components of the device simultaneously;
II. delivering gas is to the at least one gas and water injector
III. delivering water from the water tank to the at least one gas and water injector;
IV. injecting the gas and micro-fine droplets into the plasma reactor; and
V. delivering the highly concentrated NOx product to a product receiving apparatus which may be a tray, or other apparatus suitable for receiving the highly concentrated NOx product from the exit of the plasma reactor vessel, said product can then be stored, used or transferred to another container.

7. The device of claim 1 further comprising:
a seed treatment system having at least one seed treatment basket placed in a collection jar to allow exposure of seeds to either wet or dry plasma treatment as determined by the selection of treatment type using the touch screen control which is part of the system control.

8. The device of claim 5 further comprising:
at least one electronic valve to open, close and regulate the flow of water;
at least one electronic valve to control gas and air; and
a timing device for automatic operational activation and shut-off control wherein said timing device is actuated by the system control unit and is programmable for operation of the NOx production system, said control system is capable of actuating and regulating system functionality and selecting the desired functional settings, and further selecting either wet or dry treatment options.

9. A process for non-thermal plasma production of the NOx product and treatment of seeds with the device of claim 1, comprising the steps of:
I. removably attaching the at least one product receiving apparatus or collection jar and seed basket for seed treatment to the device;
II. operatively engaging the device by powering it on through the system control unit via the touch screen control, capable of actuating and regulating system functionality and selecting desired functional settings, and further selecting either wet or dry treatment options;
III. providing electricity through the device electrical system, and a pressurized external flow of air or gas to the device through the at least one gas and water injector;
IV. if wet plasma treatment is desired, further supplying water through the at least one gas and water injector;
V. engaging the at least one plasma ignition unit in the device;
VI. generating a plasma zone within the at least one plasma reactor vessel and directing it through the plasma vessel exit opening; and
VII. if desired, recirculating the product back through the non-thermal plasma treatment device one or more times to increase the concentration of a desired reactive species, which generates a ROS and RNS-enhanced NOx product.

10. The device of claim 1, further comprising:
an on-board compressor system that is configured to be mounted to the device framework that receives electrical power from the system control and starts the operation of compressing gas and sending it to the at least one gas and water injector via a hose or conduit.

11. The device of claim 1, further comprising:
a remote compression system not mounted on the device framework that receives electrical power from the system control and starts the operation of compressing gas and sending it to the at least one gas and water injector via a hose or conduit.

12. The device of claim 1, further comprising:
a compressed oxygen tank and a compressed nitrogen tank and a gas flow control valve and a gas mixer used to send precise volumes of each to exit the at least one gas flow control valve, entering the gas mixer and traveling to the at least one gas and water injector via a hose or conduit.

13. The device of claim 1, further comprising:
an oxygen concentrator system that is configured to be mounted to the device framework incorporating a built-in compressor which allows it to increase the percentage of oxygen in the gas. The gas travels to the at least one gas and water injector via a hose or conduit.

14. A process for NOx production using the device of claim 1;
I. powering the NOx production device of produces the NOx product via the use of utility power, gas, and water;
II. using the touch screen control to operate the system in the manner and timing as desired to initiate the electrical power to the plasma ignition, the water flow solenoid valve, the cooling fan and to one of the four gas supply systems illustrated;
III. flowing the water from the water tank through the water flow solenoid valve and into the at least one gas and water injector via a hose or conduit; while simultaneously, gas is supplied from one of the four gas supply systems illustrated to the at least one gas and water injector;
IV. Supplying both gas and water to the at least one gas and water injector, a discharge of gas and micro-fine droplets exit the connection of the at least one gas and water injector as illustrated; flowing into the plasma reactor wherein the micro-fine droplets are exposed to the high current charge that occurs between the ground and the ignition electrodes;
V. the micro-fine droplets then travel to the plasma zone and therein undergo a chemical transformation wherein the gas is ionized, radicalized and become unstable in the presence of the micro-fine droplets of water; said droplets being typically 8 u to 20 u in size and are able to disperse within the plasma zone without quenching or shorting out the plasma discharge; and
VI. as a result of completing steps I-V, the concentration of NOx is greatly enhanced and more effective for its intended applications.

15. An expanded NOx production device of claim 1 further compromising;
at least one additional plasma ignition units, at least one additional gas and water injectors and at least one additional plasma reactor assembly, resulting in expanded production of the highly concentrated NOx product.

16. A further expanded NOx production device of claim 1 further comprising;
using the steps shown in claim 12 and having the at least one additional gas and water injector emitting gas and micro-fine water droplets into a manifold.
